(19) United States
(12) Patent Application Publication
(10) Pub. No.: US 2011/0066504 A1
(43) Pub. Date: Mar. 17, 2011

(54) SYSTEM FOR PROVIDING PROMOTION INFORMATION

(76) Inventors: Ehud Chatow, Palo Alto, CA (US); Benjamin I. Dempster, Palo Alto, CA (US)

(21) Appl. No.: 12/561,302

(22) Filed: Sep. 17, 2009

(51) Int. Cl. G06Q 30/00

(52) U.S. Cl. 705/14.65

(57) ABSTRACT

A system for providing promotion information includes a mobile electronic device configured to scan a printed tag on a first commercial offering being offered for sale, and wirelessly transmit corresponding tag information. A promotion system is configured to receive the transmitted tag information, identify promotion information associated with the first commercial offering based on the tag information, and wirelessly transmit the identified promotion information to the mobile electronic device.

### BACKGROUND

In-store promotions are typically highly manual, and involve the printing of point of purchase (POP) print elements (e.g., shelf tag promotions) and coordinating online and print circular specials (e.g., newspaper coupons). Such promotional techniques do not enable retailers and brand owners to have closed-loop promotional capabilities such as knowing which products and related promotions were viewed, and which promotions were acted upon for specific products in specific locations, by specific users. Conventional in-store promotional techniques do not enable brand owners and retailers to collect information (e.g., clickstream type profiling information) on the consumer and the consumer's interest in the product, and do not enable the consumer to receive more information on the product, related products (e.g., co-promoted products), and community or peer recommendations.

### BRIEF DESCRIPTION OF THE DRAWINGS

FIG. 1 is a block diagram illustrating a system for providing product or service promotion information according to one embodiment.

FIG. 2 is a block diagram illustrating a mobile electronic device for use with the system shown in FIG. 1 according to one embodiment.

FIG. 3 is a flow diagram illustrating a method for providing product or service promotion information according to one embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., may be used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

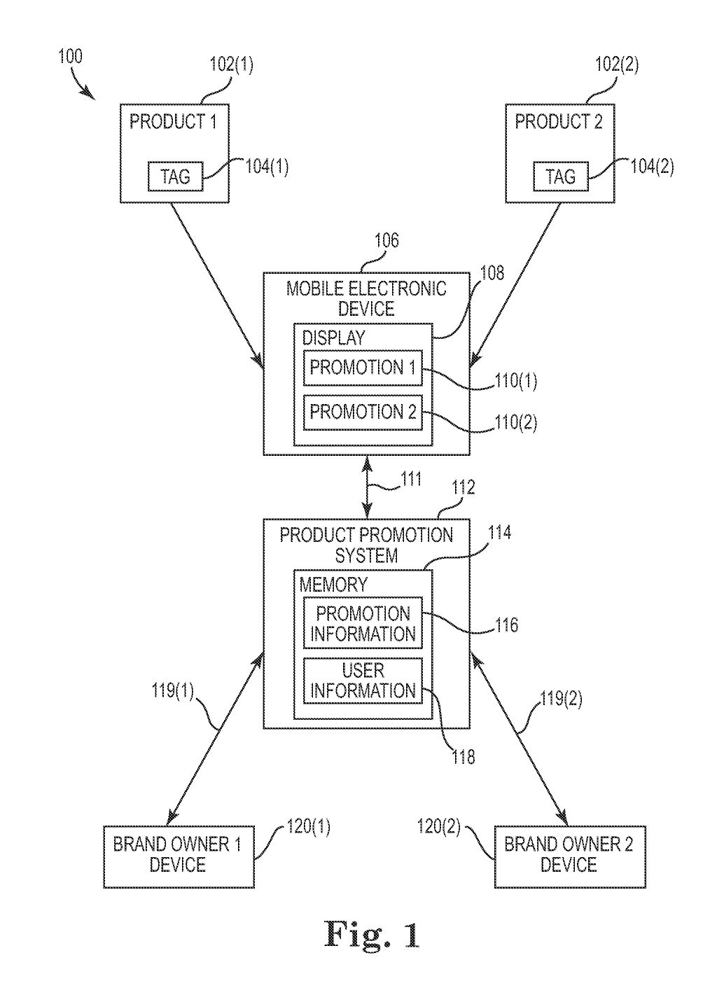

FIG. 1 is a block diagram illustrating a system 100 for providing product or service promotion information according to one embodiment. System 100 according to one embodiment provides a multi-user, web-based service that enables new forms of mobile promotions which can be tracked by brand owners and retailers when consumers interact with digital tags on product packaging elements using mobile devices. In one embodiment, system 100 provides closed-loop tracking of product specific promotions. In the following description, system 100 will primarily be discussed in the context of providing promotion information for products being offered for sale. However, it will be understood that system 100 may be used to provide promotion information for any type of commercial offering. A “commercial offering” as used herein refers to a product or service that is being offered for sale.

System 100 includes a mobile electronic device 106, a product promotion system 112, and brand owner devices 120(1) and 120(2) (collectively referred to as brand owner devices 120). Mobile electronic device 106 includes a display 108. In one embodiment, mobile electronic device 106 is a cellular telephone. In another embodiment, mobile electronic device 106 is another type of portable device, such as a personal digital assistant (PDA), portable scanner, or other device. Product promotion system 112 includes a memory 114 that stores product promotion information 116 and user information 118. In one embodiment, product promotion system 112 and brand owner devices 120 are each a computer system or computing device (e.g., a desktop computer system, or a laptop computer or other portable computing device). Mobile electronic device 106 is communicatively coupled to product promotion system 112 via communication link 111. In one embodiment, communication link is a wireless communication link. Product promotion system 112 is coupled to brand owner devices 120 via communication links 119(1) and 119(2) (collectively referred to as communication links 119). In one embodiment, communication links 119 are wired or wireless communication links.

The mobile electronic device 106 according to one embodiment is configured to scan printed tags 104(1) and 104(2) (collectively referred to as tags 104) on respective products 102(1) and 102(2) (collectively referred to as products 102) being offered for sale, and wirelessly transmit corresponding tag information to product promotion system 112 via communication link 111. The product promotion system 112 according to one embodiment is configured to receive the transmitted tag information, identify product promotion information 116 associated with the scanned products 102 based on the received tag information, and wirelessly transmit the identified product promotion information to the mobile electronic device 106 via communication link 111. The mobile electronic device 106 displays the received product promotion information (e.g., promotions 110(1) and 110(2) (collectively referred to as promotions 110)) on display 108. The promotions 110 according to one embodiment can include text, images, video clips, as well as other types of promotional information. The tags 104 printed on the products 102 enable consumers to receive and view targeted, user-specific promotions after capturing the tags 104 using a mobile device 106. System 100 according to one embodiment also enables brand owners to dynamically create or update their campaign as the tags 104 send the user to the online world for viewing the latest updates on the campaign.

In one embodiment, each of the tags 104 includes a code. The codes may be implemented with 1D or 2D barcodes, either visible or invisible to the human eye, and either black and white or color. In one embodiment, the mobile electronic device 106 is configured to generate an image of each of the tags 104 and analyze each image to extract the associated code. In one form of this embodiment, the mobile electronic device 106 then includes the extracted codes in the tag information transmitted to product promotion system 112. In another embodiment, the transmitted tag information includes the image of the tag captured by the mobile electronic device 106, and the product promotion system 112 is configured to analyze the image to extract the code. In one embodiment, each product 102 has an associated code, and each code is associated with a set of promotion information 116. Thus, given a code associated with a product 102 that has just been scanned by a user using device 106, production promotion system 112 is able to identify a set of promotion information 116 associated with that code, and correspondingly with that product 102.

In one embodiment, the product promotion system 112 is configured to store a plurality of sets of user profile information or user information 118, with each set of user profile information associated with a particular user of the system 100, and mobile electronic device 106 is configured to transmit user identification information along with the tag information to product promotion system 112. In one embodiment, when the product promotion system 112 receives tag information for one of the products 102, product promotion system 112 identifies the set of product promotion information 116 associated with that product 102 based on the received tag information and user identification information, and based on one of the sets of user profile information 118 associated with the user of the mobile electronic device 106. Each set of the user profile information 118 according to one embodiment includes a history of products scanned and user preferences. By storing user information 118, product promotion system 112 is able to provide targeted delivery of product promotions to consumers based upon a recommendation engine in system 112 that uses different types of user information 118, such as consumer profile and preferences, historical purchase records, history of scanned products, history of promotions redeemed, shopping lists input by consumer, and other contextual information such as location and time of day to increase the relevance of product promotions and increase their effectiveness in driving sales. In one embodiment, mobile electronic device 106 is configured to allow a user to set parameters and levels for personalization of promotions.

In one embodiment, the mobile electronic device 106 includes global positioning satellite (GPS) capabilities, and is configured to transmit location information along with the tag information, with the location information indicating a current location of the mobile electronic device 106. In one form of this embodiment, the product promotion system 112 identifies product promotion information 116 associated with a scanned product 102 based on the tag information and based on the transmitted location information.

In one embodiment, the product promotion information 116 that is transmitted to mobile electronic device 106 for a first scanned product (e.g., product 102(1)) provides promotional information for that product as well as a second (non-scanned) product (e.g., product 102(2)). In one embodiment, the first product and the second product are different types of products. For example, product promotion system 112 may transmit promotions for related and complementary products to any tagged product that is selected by the consumer within the same retail store. System 100 according to one embodiment enables cross-promotions where a wine brand owner, for example, could bundle a purchase with a specific cheese type brand owner, and each brand owner would agree on the level of promotion for the bundle. This is currently something that is typically coordinated by a retailer in an in-store environment using a very manual process to execute. System 100 allows brand owners to coordinate these cross-promotions outside of a retailer environment when products are used outside of stores. System 100 according to one embodiment coordinates these in-store cross-product promotions based on economic rules as defined by the retailers and brand owners. This capability is based on integration of the system 100 with retailer inventory and supply chain systems, including product location data within stores. System 100 according to one embodiment also enables brand owners to develop in-store cross-promotions by coordinating promotions with retailers. Currently, these kinds of in-store cross-promotions are mostly controlled by retailers and again are highly manual in terms of execution. In this embodiment, the product promotions are flexible to change based on time of day (based on statistical buying patterns) or inventory status close to real time. The promotions and cross promotions can also change to create an improved marketing and sales campaign, testing several promotions in a short period of time before deciding which one works best and which promotion optimizes the profit for the retailer and brand owners.

The product promotion system 112 according to one embodiment is configured to be accessed by brand owners using brand owner devices 120 to provide the product promotion information 116 to system 112. System 100 according to one embodiment enables retailers and brand owners to coordinate the delivery of promotions to consumers based upon their mobile device views/clicks of tags 104 on product packaging, either in the retail environment or when used outside of the store. System 100 enables brand owners and retailers to automate product promotions and receive real-time data relating to those promotions (product view and “clicks”). A brand owner can use tags 104 with a unique code for each individual product 102 of that brand owner (e.g., each individual product 102 has a different, unique code) to facilitate tracking of individual products 102, or the brand owner can use tags 104 with a unique code for groups or types of products 102 (e.g., each individual product 102 within a given group or type has the same code as the other products in that group or type, which is different than the codes used for products 102 in other groups or types).

System 100 enables retailers and brand owners to have closed-loop promotional capabilities such as knowing which products 102 and related promotions were viewed, and which promotions were acted upon for specific products in specific locations, by specific users. The web-based service provided by system 100 according to one embodiment enables new classes of data that can be used to improve business intelligence and targeting analytics for retailers and brand owners. Such information includes number and frequency of specific product views and clicks, time spent viewing product promotions and related media content for a specific product, and the number of products directly viewed as a result of an in-store cross-promotion. System 100 according to one embodiment connects the consumer to the brand owner and retailer by capturing a tag 104 on a product 102 with a mobile device 106, while enabling the brand owner and retailer to both collect information (e.g., clickstream type profiling information) on the consumer and the consumer's interest in the product, and enabling the consumer to receive more information on the product, related products (co-promoted), and community or peer recommendations.

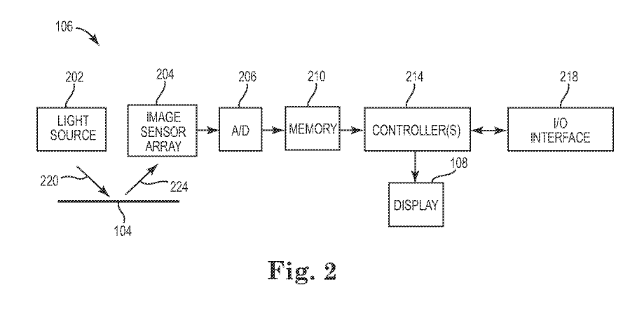

FIG. 2 is a block diagram illustrating a mobile electronic device 106 for use with the system 100 (FIG. 1) for providing product or service promotion information according to one embodiment. Device 106 includes light source 202, image sensor array 204, analog-to-digital (A/D) converter 206, memory 210, at least one controller 214, display 108, and input/output (I/O) interface 218. In one embodiment, controller 214 is configured to control light source 202, image sensor array 204, A/D converter 206, memory 210, display 108, and I/O interface 218, although all of the connections between these elements are not shown to simplify the illustration. In one embodiment, image sensor array 204, A/D converter 206, memory 210, controller 214, and I/O interface 218 are implemented in a single semiconductor chip.

In operation according to one embodiment, light source 202 illuminates a tag 104 with light 220. The light 220 is reflected by surface 222, as indicated by reflected light 224, and the reflected light 224 is received by image sensor array 204. The reflected light 224 may be directed onto the image sensor array 204 with a lens (not shown) within device 106. In one embodiment, image sensor array 204 is a two-dimensional CMOS image sensor array with a plurality of rows and a plurality of columns of image sensor elements. Image sensor array 204 generates image data (e.g., two-dimensional image frames) based on the received light 224, and outputs the image data to A/D converter 206. A/D converter 206 converts the received image data into two-dimensional digital images, and outputs the digital images to memory 210.

In one embodiment, controller 214 accesses a digital image of a tag 104 from memory 210 and analyzes the image to extract the associated code. Controller 214 then wirelessly transmits the extracted code to product promotion system 112 (FIG. 1) via I/O interface 218. In another embodiment, controller 214 transmits the image of the tag 104 to the product promotion system 112 via I/O interface 218, and the product promotion system 112 is configured to analyze the image to extract the code. The product promotion system 112 identifies product promotion information 116 based on the extracted code, and wirelessly transmits the identified product promotion information to the mobile electronic device 106 via communication link 111 (FIG. 1). Controller 214 receives the wirelessly transmitted product promotion information via I/O interface 218, and displays the received product promotion information on display 108.

It will be understood by a person of ordinary skill in the art that functions performed by system 100 may be implemented in hardware, software, firmware, or any combination thereof. The implementation may be via a microprocessor, programmable logic device, or state machine. Components of system 100 may reside in software on one or more computer-readable mediums that store computer-executable instructions for performing a method. The term computer-readable medium as used herein is defined to include any kind of memory, volatile or non-volatile, such as floppy disks, hard disks, CD-ROMs, flash memory, read-only memory, and random access memory.

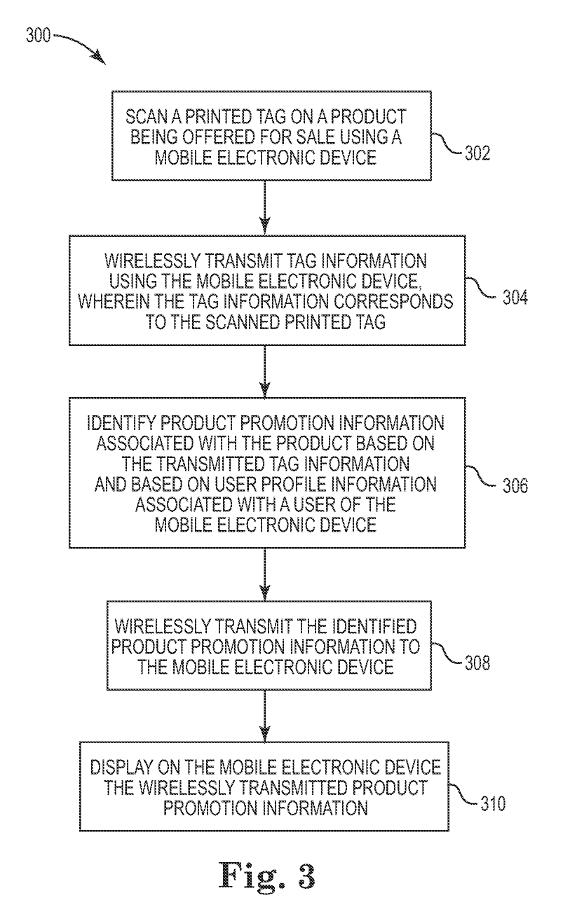

FIG. 3 is a flow diagram illustrating a method 300 for providing product or service promotion information according to one embodiment. In one embodiment, system 100 (FIG. 1) is configured to perform method 300. At 302 in method 300, a printed tag 104 on a product 102 being offered for sale is scanned using a mobile electronic device 106. At 304, tag information corresponding to the scanned printed tag is wirelessly transmitted using the mobile electronic device 106. At 306, product promotion information 116 associated with the product 102 is identified based on the transmitted tag information and based on user profile information 118 associated with a user of the mobile electronic device 106. At 308, the identified product promotion information 116 is wirelessly transmitted to the mobile electronic device 106. At 310, the mobile electronic device 106 receives and displays the wirelessly transmitted product promotion information.

Although the present disclosure has been described with reference to preferred embodiments, workers skilled in the art will recognize that changes can be made in form and detail without departing from the spirit and scope of the present disclosure.

What is claimed is:

1. A system for providing promotion information, comprising:
a mobile electronic device configured to scan a printed tag on a first commercial offering being offered for sale, and wirelessly transmit corresponding tag information; and
a promotion system configured to receive the transmitted tag information, identify promotion information associated with the first commercial offering based on the tag information, and wirelessly transmit the identified promotion information to the mobile electronic device.

2. The system of claim 1, wherein the commercial offering is one of a product and a service, and wherein the mobile electronic device is configured to display the transmitted promotion information.

3. The system of claim 1, wherein the mobile electronic device is configured to generate an image of the printed tag and analyze the image to extract a code, and wherein the transmitted tag information comprises the extracted code.

4. The system of claim 1, wherein the mobile electronic device is configured to generate an image of the printed tag, wherein the transmitted tag information comprises the image, and wherein the promotion system is configured to analyze the image to extract a code.

5. The system of claim 1, wherein the promotion system is configured to store a plurality of sets of user profile information, each set of user profile information associated with a particular user of the system.

6. The system of claim 5, wherein the promotion system is configured to identify the promotion information associated with the first commercial offering based on the tag information and based on one of the sets of user profile information associated with a user of the mobile electronic device.

7. The system of claim 6, wherein each set of the user profile information comprises at least one of a history of products scanned, a history of promotions redeemed, a shopping list, and user preferences.

8. The system of claim 1, wherein the mobile electronic device is configured to transmit location information along with the tag information, the location information indicating a current location of the mobile electronic device.

9. The system of claim 8, wherein the product promotion system is configured to identify the promotion information associated with the first commercial offering based on the tag information and based on the transmitted location information.

10. The system of claim 1, wherein the first commercial offering is a first product, and wherein the promotion information provides promotional information for the first product and a second product.

11. The system of claim 10, wherein the first product and the second product are different types of products.

12. The system of claim 1, wherein the mobile electronic device comprises a cellular telephone, and the promotion system comprises at least one computer system.

13. The system of claim 1, wherein the promotion system is configured to be accessed by a brand owner to provide the promotion information.

14. The system of claim 1, wherein the printed tag comprises a 1D or 2D barcode.

15. A method for providing promotion information, comprising:
scanning a printed tag on a commercial offering being offered for sale using a mobile electronic device;
wirelessly transmitting tag information using the mobile electronic device, the tag information corresponding to the scanned printed tag;
identifying promotion information associated with the commercial offering based on the transmitted tag information; and
wirelessly transmitting the identified promotion information to the mobile electronic device.

16. The method of claim 15, and further comprising:
displaying on the mobile electronic device the wirelessly transmitted promotion information.

17. The method of claim 16, wherein scanning a printed tag comprises:
generating an image of the printed tag; and
analyzing the image with the mobile electronic device to extract a code, and wherein the transmitted tag information comprises the extracted code.

18. The method of claim 15, and further comprising:
storing a plurality of sets of user profile information, each set of user profile information associated with a particular user; and
identifying the promotion information associated with the commercial offering based on the transmitted tag information and based on one of the sets of user profile information associated with a user of the mobile electronic device.

19. The method of claim 15, and further comprising:
wirelessly transmitting location information with the mobile electronic device, the location information indicating a current location of the mobile electronic device; and
identifying the promotion information associated with the commercial offering based on the tag information and based on the transmitted location information.

20. A system for providing promotion information, comprising:
a mobile electronic device configured to scan a printed tag on a commercial offering being offered for sale, and wirelessly transmit corresponding tag information; and
a promotion system configured to receive the transmitted tag information, identify promotion information associated with the commercial offering based on the tag information and based on user profile information associated with a user of the mobile electronic device, and wirelessly transmit the identified promotion information to the mobile electronic device.
